(19) United States
(12) Patent Application Publication
(10) Pub. No.: US 2026/0074984 A1
(43) Pub. Date: Mar. 12, 2026

(54) MESSAGE FORWARDING METHOD, APPARATUS AND DEVICE, AND NON-VOLATILE READABLE STORAGE MEDIUM

(71) Applicant: SUZHOU METABRAIN INTELLIGENT TECHNOLOGY CO., LTD., Suzhou, Jiangsu (CN)

(72) Inventors: Weijie LIAO, Suzhou, Jiangsu (CN); Yujin XU, Suzhou, Jiangsu (CN); Yiting LAI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/863,953

(22) PCT Filed: Feb. 23, 2023
(86) PCT No.: PCT/CN2023/077972

§ 371 Date: Nov. 7, 2024

(30) Foreign Application Priority Data
Sep. 15, 2022 (CN) 202211118797.6

(51) Int. Cl. H04L 45/00; H04L 43/0876; H04L 49/55; H04L 49/552

(52) U.S. Cl. CPC H04L 45/22; H04L 43/0876; H04L 49/552; H04L 49/557

(57) ABSTRACT

Embodiments of the present disclosure provide a message forwarding method. The message forwarding method includes the following operations: receiving a target message to be forwarded; acquiring a preset main message forwarding path; when it is determined that the main message forwarding path is abnormal, acquiring a redundant backup message forwarding path selected according to device efficiency utilization states; and forwarding the target message by using the redundant backup message forwarding path.

### CROSS-REFERENCE TO RELATED APPLICATION

The present application is a National Stage Application of PCT International Application No.: PCT/CN2023/077972 filed on Feb. 23, 2023, which claims priority to Chinese Patent Application 202211118797.6, filed in the China National Intellectual Property Administration on Sep. 15, 2022, the disclosure of which is incorporated herein by reference in its entirety.

### TECHNICAL FIELD

Embodiments of the present disclosure relate to the technical field of switches, and in particular to a message forwarding method, apparatus and device, and a non-volatile readable storage medium.

### BACKGROUND

In order to improve the reliability of a system, repeated parts or devices are deliberately configured in a system architecture in the consideration of backup, failure security and improvement in the stability of the system, so that if a part of devices is abnormal (e.g., shutdown, disconnection and the like) in the system under the architecture of a redundancy mechanism, the operation of the system is still not affected. The stronger the redundancy mechanism is, the wider an abnormality range that the redundancy mechanism is able to bear is, or the shorter a convergence time is. The most common redundancy protocols in the network related field include a Spanning Tree Protocol (STP), a Rapid Spanning Tree Protocol (RSTP), a Multiple Spanning Tree Protocol (MSTP), etc.

In the current redundancy mechanism, when an initial ring topology emerges, Media Access Control (MAC) addresses of devices are generally used as a judging decision reference in combination with port numbers. This piece of combination data is carried within messages during the protocol communication phase and transmitted among devices. Values in the devices are finally compared to make a decision on a redundant path, for example, a path having the minimum combination value in the ring topology is generally used as a redundant backup path to complete an initial redundancy establishment process. Upon a topology change in the environment, the related protocol technology uses the redundant backup path mentioned above as a new initial path, and converts the changed path into a new redundant backup path, so that the overall online state of the environment is normal. However, the device tends to operate at a high utilization rate for a long time under this decision state, increasing the likelihood of anomalies or congestion within that section of the path, which may affect the stability of the system.

In summary, how to effectively solve the problem that, the message forwarding method of the related art easily causes the device to operate at a high utilization rate for a long time under the decision state, increasing the likelihood of anomalies or congestion within a section of the path, which may affect the stability of the system, is an urgent problem to be solved by those having ordinary skill in the art.

### SUMMARY

Embodiments of the present disclosure provide a message forwarding method, which greatly reduces the likelihood of anomalies or congestion occurring in a message forwarding path, improves the message forwarding success rate, and improves the system stability. The embodiments of the present disclosure also provide a message forwarding apparatus and device, and a non-volatile readable storage medium.

To solve the above technical problems, the embodiments of the present disclosure provide the following technical solutions.

A message forwarding method includes:
receiving a target message to be forwarded;
acquiring a preset main message forwarding path;
when it is determined that the main message forwarding path is abnormal, acquiring a redundant backup message forwarding path selected according to device efficiency utilization states; and
forwarding the target message by using the redundant backup message forwarding path.

In an exemplary implementation of the embodiments of the present disclosure, the message forwarding method further includes a process of selecting the redundant backup message forwarding path, wherein the process of selecting the redundant backup message forwarding path includes:
respectively acquiring the device efficiency utilization states of switches;
determining a target switch having a maximum device efficiency utilization rate according to the device efficiency utilization states;
acquiring target device efficiency utilization rates of two neighboring switches that establish a direct communication connection with the target switch;
determining, as a target neighboring switch, one of the two neighboring switches that corresponds to the greater one of the two target device efficiency utilization rates; and
determining, as the redundant backup message forwarding path, a message forwarding path between the target switch and the target neighboring switch.

In an exemplary implementation of the embodiments of the present disclosure, determining the target switch having the maximum device efficiency utilization rate according to the device efficiency utilization states includes:
determining a target switch having a maximum CPU utilization rate according to the device efficiency utilization states;
in the exemplary implementation, acquiring the target device efficiency utilization rates of the two neighboring switches that establish the direct communication connection with the target switch includes:
acquiring target CPU utilization rates of the two neighboring switches that establish the direct communication connection with the target switch; and
in the exemplary implementation, determining, as the target neighboring switch, one of the two neighboring switches that corresponds to the greater one of the two target device efficiency utilization rates includes:
determining, as the target neighboring switch, one of the two neighboring switches that corresponds to the greater one of the two target CPU utilization rates.

In an exemplary implementation of the embodiments of the present disclosure, determining the target switch having the maximum device efficiency utilization rate according to the device efficiency utilization states includes:
determining a target switch having a maximum memory utilization rate according to the device efficiency utilization states;
in the exemplary implementation, acquiring the target device efficiency utilization rates of the two neighboring switches that establish the direct communication connection with the target switch includes:
acquiring target memory utilization rates of the two neighboring switches that establish the direct communication connection with the target switch; and
in the exemplary implementation, determining, as the target neighboring switch, one of the two neighboring switches that corresponds to the greater one of the two target device efficiency utilization rates includes:
determining, as the target neighboring switch, one of the two neighboring switches that corresponds to the greater one of the two target memory utilization rates.

In an exemplary implementation of the embodiments of the present disclosure, determining the target switch having the maximum device efficiency utilization rate according to the device efficiency utilization states includes:
determining a target switch having a minimum access control list rule count according to the device efficiency utilization states;
in the exemplary implementation, acquiring the target device efficiency utilization rates of the two neighboring switches that establish the direct communication connection with the target switch includes:
acquiring target access control list rule counts of the two neighboring switches that establish the direct communication connection with the target switch; and
in the exemplary implementation, determining, as the target neighboring switch, one of the two neighboring switches that corresponds to the greater one of the two target device efficiency utilization rates includes:
determining, as the target neighboring switch, one of the two neighboring switch that corresponds to the smaller one of the two target access control list rule counts.

In an exemplary implementation of the embodiments of the present disclosure, determining the target switch having the maximum device efficiency utilization rate according to the device efficiency utilization states includes:
determining a target switch having a maximum port utilization rate according to the device efficiency utilization states;
in the exemplary implementation, acquiring the target device efficiency utilization rates of the two neighboring switches that establish the direct communication connection with the target switch includes:
acquiring target port utilization rates of the two neighboring switches that establish the direct communication connection with the target switch; and
in the exemplary implementation, determining, as the target neighboring switch, one of the two neighboring switches that corresponds to the greater one of the two target device efficiency utilization rates includes:
determining, as the target neighboring switch, one of the two neighboring switches that corresponds to the greater one of the two target port utilization rates.

In an exemplary implementation of the embodiments of the present disclosure, determining the target switch having the maximum device efficiency utilization rate according to the device efficiency utilization states includes:
determining a target switch having a maximum queue utilization rate according to the device efficiency utilization states;
in the exemplary implementation, acquiring the target device efficiency utilization rates of the two neighboring switches that establish the direct communication connection with the target switch includes:
acquiring target queue utilization rates of the two neighboring switches that establish the direct communication connection with the target switch; and
in the exemplary implementation, determining, as the target neighboring switch, one of the two neighboring switches that corresponds to the greater one of the two target device efficiency utilization rates includes:
determining, as the target neighboring switch, one of the two neighboring switches that corresponds to the greater one of the two target queue utilization rates.

In an exemplary implementation of the embodiments of the present disclosure, determining the target switch having the maximum device efficiency utilization rate according to the device efficiency utilization states includes:
determining a target switch having a maximum port packet loss statistical number according to the device efficiency utilization states;
in the exemplary implementation, acquiring the target device efficiency utilization rates of the two neighboring switches that establish the direct communication connection with the target switch includes:
acquiring target port packet loss statistical numbers of the two neighboring switches that establish the direct communication connection with the target switch; and
in the exemplary implementation, determining, as the target neighboring switch, one of the two neighboring switches that corresponds to the greater one of the two target device efficiency utilization rates includes:
determining, as the target neighboring switch, one of the two neighboring switches that corresponds to the greater one of the two target port packet loss statistical numbers.

In an exemplary implementation of the embodiments of the present disclosure, respectively acquiring the device efficiency utilization states of the switches includes:
respectively acquiring efficiency index utilization rates corresponding to each of the switches;
in the exemplary implementation, determining the target switch having the maximum device efficiency utilization rate according to the device efficiency utilization states includes:
acquiring preset weights corresponding to respective efficiency indexes;
for each of the switches, performing weighted average on the efficiency index utilization rates according to the preset weights, so as to obtain the device efficiency utilization rate; and
determining, as the target switch, the switch having the maximum device efficiency utilization rate.

In an exemplary implementation of the embodiments of the present disclosure, determining the target switch having the maximum device efficiency utilization rate according to the device efficiency utilization states includes:
when it is determined according to the device efficiency utilization states that the number of switches having the maximum device efficiency utilization rate is greater than 1, acquiring Media Access Control (MAC) addresses and port numbers, which respectively correspond to the switches having the maximum device efficiency utilization rate; and
selecting, according to the MAC addresses and the port numbers, the target switch from the switches having the maximum device efficiency utilization rate.

In an exemplary implementation of the embodiments of the present disclosure, selecting, according to the MAC addresses and the port numbers, the target switch from the switches having the maximum device efficiency utilization rate includes:
determining, as the target switch, a switch having a minimum combination of the MAC address and the port number.

In an exemplary implementation of the embodiments of the present disclosure, determining, as the target neighboring switch, one of the two neighboring switches that corresponds to the greater one of the two target device efficiency utilization rates includes:
when the two target device efficiency utilization rates are the same, acquiring MAC addresses and port numbers, which respectively correspond to the two neighboring switches; and
selecting the target neighboring switch from the two neighboring switches according to the MAC addresses and the port numbers.

In an exemplary implementation of the embodiments of the present disclosure, selecting the target neighboring switch from the two neighboring switches according to the MAC addresses and the port numbers includes:
determining, as the target neighboring switch, a neighboring switch having a minimum combination of the MAC address and the port number.

In an exemplary implementation of the embodiments of the present disclosure, the message forwarding method further includes: after determining the target switch having the maximum device efficiency utilization rate according to the device efficiency utilization states,
judging whether the device efficiency utilization rate of the target switch reaches a preset upper limit of device efficiency utilization rate; and
in a case where it is judged that the device efficiency utilization rate of the target switch reaches the preset upper limit of device efficiency utilization rate, outputting prompt information indicating that the device efficiency utilization rate is too high.

In an exemplary implementation of the embodiments of the present disclosure, forwarding the target message by using the redundant backup message forwarding path includes:
when an initiative restart mechanism is triggered, forwarding the target message by using the redundant backup message forwarding path.

In an exemplary implementation of the embodiments of the present disclosure, acquiring the target device efficiency utilization rates of the two neighboring switches that establish the direct communication connection with the target switch includes:
in a case where it is judged that the device efficiency utilization rate of the target switch does not reach a preset upper limit of device efficiency utilization rate, acquiring the target device efficiency utilization rates of the two neighboring switches that establish the direct communication connection with the target switch.

In an exemplary implementation of the embodiments of the present disclosure, the message forwarding method further includes:
determining that the two target device efficiency utilization rates are the same when the target CPU utilization rates of the two neighboring switches are the same, or the target memory utilization rates of the two neighboring switches are the same, or the target access control list rule counts of the two neighboring switches are the same, or the target port utilization rates of the two neighboring switches are the same, or the target queue utilization rates of the two neighboring switches are the same, or the target port packet loss statistical numbers of the two neighboring switches are the same.

A message forwarding apparatus includes:
a message receiving module, configured to receive a target message to be forwarded;
a main path acquisition module, configured to acquire a preset main message forwarding path;
a backup path acquisition module, configured to: when it is determined that the main message forwarding path is abnormal, acquire a redundant backup message forwarding path selected according to device efficiency utilization states; and
a message forwarding module, configured to forward the target message by using the redundant backup message forwarding path.

A message forwarding device includes:
a memory, configured to store a computer program; and
a processor, configured to implement the operations of the message forwarding method as described above when executing the computer program.

A non-volatile readable storage medium stores a computer program, wherein the computer program, when executed by a processor, implements the operations of the message forwarding method as described above.

In the message forwarding method provided in the embodiments of the present disclosure, the target message to be forwarded is received; the preset main message forwarding path is acquired; when it is determined that the main message forwarding path is abnormal, the redundant backup message forwarding path selected according to the device efficiency utilization states is acquired; and the target message is forwarded by using the redundant backup message forwarding path.

It can be seen from the above technical solutions that the redundant backup message forwarding path is selected in advance from message forwarding paths according to the device efficiency utilization states, and after the target message to be forwarded is received, when the preset main message forwarding path is abnormal, the target message is forwarded by using the redundant backup message forwarding path. Therefore, devices are effectively prevented from being in a high utilization rate state for a long time, the likelihood of anomalies or congestion occurring in the message forwarding paths is greatly reduced, the message forwarding success rate is improved, and the system stability is improved.

Correspondingly, the embodiments of the present disclosure further provide a message forwarding apparatus and device, and a non-volatile readable storage medium, which correspond to the above message forwarding method and have the above technical effects, thus details are not described herein again.

### BRIEF DESCRIPTION OF THE DRAWINGS

To illustrate technical solutions in the embodiments of the present disclosure or in the related art more clearly, a brief introduction on the drawings which are needed in the description of the embodiments or the related art is given below. Apparently, the drawings in the description below are merely some of the embodiments of the present disclosure, based on which other drawings may be obtained by those having ordinary skill in the art without any creative effort.

FIG. 1 is a schematic diagram of a redundancy mechanism decision situation in the related art;

FIG. 2 is a schematic diagram of a redundancy mechanism decision situation in the related art in which access control list rule counts are labeled;

FIG. 3 is a schematic diagram of a redundancy mechanism decision situation in the related art in which CPU utilization rates are labeled;

FIG. 4 is an implementation flowchart of a message forwarding method in some embodiments of the present disclosure;

FIG. 5 is another implementation flowchart of a message forwarding method in some embodiments of the present disclosure;

FIG. 6 is a schematic diagram of a redundancy mechanism decision situation in some embodiments of the present disclosure in which access control list rule counts are labeled;

FIG. 7 is a schematic diagram of a redundancy mechanism decision situation in some embodiments of the present disclosure in which CPU utilization rates are labeled;

FIG. 8 is a structural block diagram of a message forwarding apparatus in some embodiments of the present disclosure;

FIG. 9 is a schematic diagram of a message forwarding device in some embodiments of the present disclosure; and

FIG. 10 is an exemplary schematic structural diagram of a message forwarding device in some embodiments of the present disclosure.

### DETAILED DESCRIPTION OF THE EMBODIMENTS

To enable those having ordinary skill in the art to better understand the solutions of the embodiments of the present disclosure, the embodiments of the present disclosure will be described in more detail below in combination with the drawing and exemplary implementations. Apparently, the described embodiments are only a part, but not all, of the embodiments of the present disclosure. All of other embodiments, obtained by those having ordinary skill in the art based on the embodiments in the present disclosure without any creative effort, shall fall into the protection scope of the embodiments of the present disclosure.

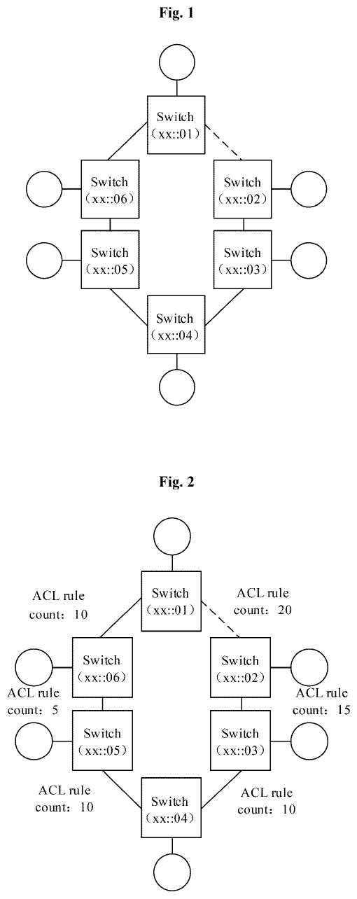

Referring to FIG. 1, FIG. 1 is a schematic diagram of a redundancy mechanism decision situation in the related art. In a message forwarding mode of the related art, a redundant backup message forwarding path is selected with reference to MAC addresses and port numbers of devices, and a path having a minimum combination value of the MAC address and the port number is used as the redundant backup message forwarding path. For example, the message forwarding path between switch [xx::01] and switch [xx::02] is used as the redundant backup message forwarding path in FIG. 1. Although the design is relatively simple and may be used directly in various devices, the MAC addresses and the port numbers are information almost unrelated to a system environment in actual scenarios. If not considering any situation in which the requirements on the system efficiency are relatively high or the overall system resource allocation is balanced, the design will not lead to any problem in operation.

As networks evolve and system environments become more complex with higher performance demands, the likelihood of triggering backup mechanisms increases when the system efficiency (performance) remains at high levels. In such cases, using MAC addresses and port numbers alone for path selection may not be sufficient to maintain high system efficiency (performance). Referring to FIG. 2, FIG. 2 is a schematic diagram of a redundancy mechanism decision situation in the related art in which access control list rule counts are labeled. Due to the requirements of system configuration and efficiency, each port path is configured with specific rules to ensure overall system stability and security. Relying solely on MAC addresses and port numbers for decision-making may inadvertently select a path with a higher number of configuration rules as the redundant path, which potentially compromises system stability. As shown in FIG. 2, if the path having the minimum combination value of the MAC address and the port number is used as the redundant backup message forwarding path, a message forwarding path having a greater access control list rule count between switch [xx::01] and switch [xx::02] will be used as the redundant backup message forwarding path, which affects the security and stability of the system.

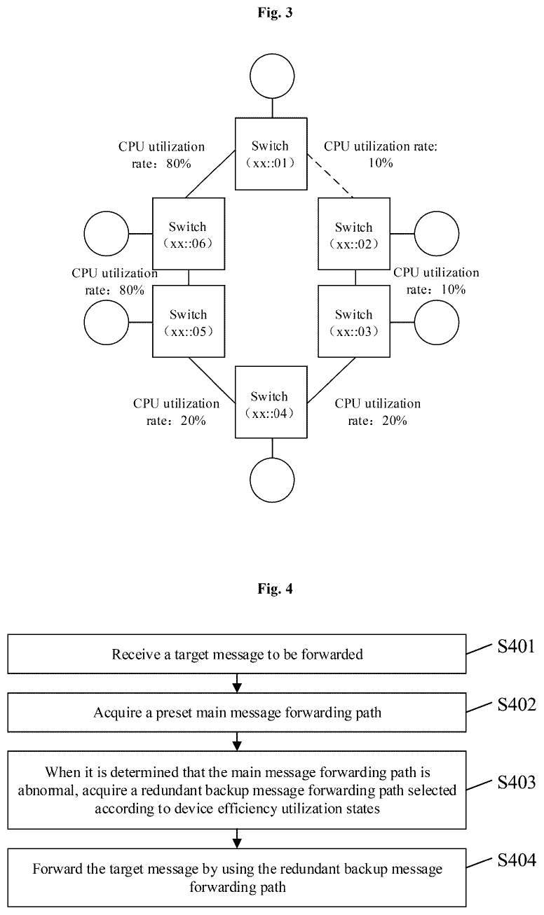

Referring to FIG. 3, FIG. 3 is a schematic diagram of a redundancy mechanism decision situation in the related art in which CPU utilization rates are labeled. Some devices in the system may maintain a high-frequency utilization state for a long time due to the imbalance of application situations, and this increases the likelihood of triggering abnormal events. Using only MAC addresses and port numbers for decision-making may overlook the actual information. For instance, as shown in FIG. 3, if the path with the smallest combination value of the MAC address and the port number is selected as the redundant backup message forwarding path, the path with a lower CPU utilization rate between switch [xx::01] and switch [xx::02] will be selected as the redundant backup message forwarding path. However, switch [xx::01] and switch [xx::02] may already be operating at low efficiency levels, and switch [xx::05] and switch [xx::06] may still operate in a high utilization rate state for a long time under this decision state, leading to potential system performance issues such as anomalies or congestion occurring in this segment of the path.

Generally speaking, since the information about the MAC addresses and the port numbers is almost not directly associated with the actual system operation conditions, decision mechanisms utilizing the MAC addresses and the port numbers will almost generate random selection results in terms of system operation conditions.

Therefore, in the message forwarding method provided in the embodiments of the present disclosure, devices are effectively prevented from being in a high utilization rate state for a long time, the likelihood of anomalies or congestion occurring in a message forwarding path is greatly reduced, the message forwarding success rate is improved, and the system stability is improved.

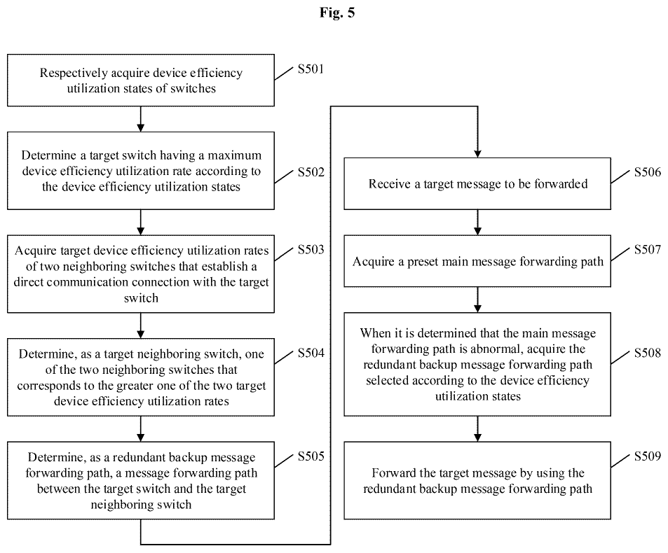

Referring to FIG. 4, FIG. 4 is an implementation flowchart of a message forwarding method in some embodiments of the present disclosure. The message forwarding method may include the following operations S401 to S404.

In operation S401, a target message to be forwarded is received.

When message forwarding needs to be performed, the target message to be forwarded is sent to a message forwarding control center, and the message forwarding control center receives the target message to be forwarded.

The message forwarding control center may be a controller capable of performing message forwarding control on switches.

In operation S402, a preset main message forwarding path is acquired.

The main message forwarding path for forwarding a message between the switches is preset for forwarding the target message to be forwarded between the switches. After the target message to be forwarded is received, the preset main message forwarding path is acquired.

In operation S403, when it is determined that the main message forwarding path is abnormal, a redundant backup message forwarding path selected according to device efficiency utilization states is acquired.

The redundant backup message forwarding path for replacing the main message forwarding path when the main message forwarding path is abnormal is preset. When setting the redundant backup message forwarding path, the redundant backup message forwarding path may be selected from message forwarding paths according to the device efficiency utilization states. After the preset main message forwarding path is acquired, it is judged whether the main message forwarding path is normal, for example, it is respectively judged whether a communication between neighboring switches is normal. When it is determined that the main message forwarding path is abnormal, the redundant backup message forwarding path selected according to the device efficiency utilization states is acquired.

In operation S404, the target message is forwarded by using the redundant backup message forwarding path.

After the redundant backup message forwarding path selected according to the device efficiency utilization states is acquired, the target message is forwarded by using the redundant backup message forwarding path. By selecting the redundant backup message forwarding path from the message forwarding paths according to the device efficiency utilization states, the devices are prevented from being in a high utilization rate state for a long time, and the likelihood of anomalies or congestion occurring in the message forwarding paths is greatly reduced, thereby improving the system stability.

In an exemplary implementation of the embodiments of the present disclosure, the operation S404 may be implemented in the following manner.

When an initiative restart mechanism is triggered, the target message is forwarded by using the redundant backup message forwarding path.

A trigger condition for performing message forwarding by using the redundant backup message forwarding path may be preset as follows: message forwarding is performed by using the redundant backup message forwarding path when the initiative restart mechanism is triggered. After the redundant backup message forwarding path selected according to the device efficiency utilization states is acquired, when the initiative restart mechanism is triggered, the target message is forwarded by using the redundant backup message forwarding path, thereby implementing effective control for enabling the redundant backup message forwarding path.

It can be seen from the above technical solutions that the redundant backup message forwarding path is selected in advance from the message forwarding paths according to the device efficiency utilization states, and after the target message to be forwarded is received, when the preset main message forwarding path is abnormal, the target message is forwarded by using the redundant backup message forwarding path. Therefore, devices are effectively prevented from being in the high utilization rate state for a long time, the likelihood of anomalies or congestion occurring in the message forwarding paths is greatly reduced, the message forwarding success rate is improved, and the system stability is improved.

It should be noted that, based on the above embodiments, the embodiments of the present disclosure further provide corresponding improvement solutions. In the subsequent embodiments, mutual reference may be made to the same operations or corresponding operations in the above embodiments, and mutual reference may also be made to corresponding beneficial effects, thus details are not described in the following improvement embodiments one by one.

Referring to FIG. 5, FIG. 5 is another implementation flowchart of a message forwarding method in some embodiments of the present disclosure. The message forwarding method may include the following operations S501 to S509.

In operation S501, device efficiency utilization states of switches are respectively acquired.

The information that affects a network communication device or that is related to the efficiency of a network communication system is very diversified, ranging from the information of individual sensing components to the average performance of the entire system, all of which can be considered associated information.

When a redundant backup message forwarding path is selected, the device efficiency utilization states of the switches are acquired respectively. For example, a CPU utilization rate, a memory utilization rate (also short as Memory utilization), an Access Control List rule count (ACL rule count), a port utilization state (also short as port rate), and the like of each switch may be acquired respectively.

In operation S502, a target switch having a maximum device efficiency utilization rate is determined according to the device efficiency utilization states.

After the device efficiency utilization states of the switches are acquired respectively, the target switch having the maximum device efficiency utilization rate is determined according to the device efficiency utilization states. For example, when the CPU utilization rate is used as a selection standard of the target switch, the switch having the maximum CPU utilization rate is determined as the target switch. As another example, when the memory utilization rate is used as the selection standard of the target switch, the switch having the maximum memory utilization rate is determined as the target switch. As still another example, since the smaller the access control list rule count is, the higher the utilization rate of the access control list rule is when the access control list rule is used, therefore when the access control list rule count is used as the selection standard of the target switch, the switch having the minimum access control list rule count is determined as the target switch. As yet another example, when the port utilization rate is used as the selection standard of the target switch, the switch having the maximum port utilization rate is determined as the target switch. By virtue of the method, the switch having the maximum working burden at present may be selected.

In an exemplary implementation of the embodiments of the present disclosure, the operation S501 may be implemented in the following manner.

Efficiency index utilization rates corresponding to each of the switches are respectively acquired.

Correspondingly, the operation S502 may include the following operations 1 to 3.

In operation 1, preset weights corresponding to respective efficiency indexes are acquired.

In operation 2, for each of the switches, weighted average is performed on the efficiency index utilization rates according to the preset weights, so as to obtain the device efficiency utilization rate.

In operation 3, the switch having the maximum device efficiency utilization rate is determined as the target switch.

For the sake of convenience in description, the above operations can be combined and explained together.

The efficiency indexes for selecting the redundant backup message forwarding path are preset, and weight values respectively corresponding to the efficiency indexes are set in advance according to the importance degrees of the efficiency indexes for the overall efficiency of the system. The efficiency index utilization rates corresponding to each of the switches are acquired respectively, the preset weights respectively corresponding to the efficiency indexes are acquired, for each of the switches, the weighted average is performed on the efficiency index utilization rates according to the preset weights, so as to obtain the device efficiency utilization rate, and the switch having the maximum device efficiency utilization rate is determined as the target switch. By selecting the target switch according to the device efficiency utilization rates that are obtained by performing the weighted average on the efficiency index utilization rates, the accuracy of selecting the target switch may be greatly improved, and the system stability may be ensured.

In an exemplary implementation of the embodiments of the present disclosure, the operation S502 may include the following operations 1 and 2.

In operation 1, when it is determined according to the device efficiency utilization states that the number of switches having the maximum device efficiency utilization rate is greater than 1, MAC addresses and port numbers, which respectively correspond to the switches having the maximum device efficiency utilization rate, are acquired.

In operation 2, the target switch is selected from the switches having the maximum device efficiency utilization rate according to the MAC addresses and the port numbers.

For the sake of convenience in description, the above two operations can be combined and explained together.

When the target switch having the maximum device efficiency utilization rate is determined according to the device efficiency utilization states, the number of switches having the maximum device efficiency utilization rate may be greater than 1. When it is determined according to the device efficiency utilization states that the number of switches having the maximum device efficiency utilization rate is greater than 1, the MAC addresses and the port numbers, which respectively correspond to the switches having the maximum device efficiency utilization rate, are acquired, and according to the MAC addresses and the port numbers, the target switch is selected from the switches having the maximum device efficiency utilization rate, thereby implementing the selection of only one target switch.

In an exemplary implementation of the embodiments of the present disclosure, the operation that the target switch is selected from the switches having the maximum device efficiency utilization rate according to the MAC addresses and the port numbers may be implemented in the following manner.

A switch having a minimum combination of the MAC address and the port number is determined as the target switch.

When it is determined according to the device efficiency utilization states that the number of switches having the maximum device efficiency utilization rate is greater than 1, a switch having a minimum combination of the MAC address and the port number is determined as the target switch. By using the minimum combination of the MAC address and the port number as the decision reference when multiple switches have the same maximum device efficiency utilization rate, the manner of selecting the target switch based on the combinations of the MAC addresses and the port numbers in the embodiments of the present disclosure is kept consistent with the related technology, thereby better conforming to the utilization habits of a user.

In an exemplary implementation of the embodiments of the present disclosure, after the operation S502, the message forwarding method may further include the following operations 1 and 2.

In operation 1, it is judged whether the device efficiency utilization rate of the target switch reaches a preset upper limit of device efficiency utilization rate, wherein in a case where it is judged that the device efficiency utilization rate of the target switch reaches the preset upper limit of device efficiency utilization rate, operation 2 is executed; and in a case where it is judged that the device efficiency utilization rate of the target switch does not reach the preset upper limit of device efficiency utilization rate, operation S503 is executed.

In operation 2, prompt information indicating that the device efficiency utilization rate is too high is output.

For the sake of convenience in description, the above two operations can be combined and explained together.

After the target switch having the maximum device efficiency utilization rate is determined according to the device efficiency utilization states, it is judged whether the device efficiency utilization rate of the target switch reaches the preset upper limit of device efficiency utilization rate, in a case where it is judged that the device efficiency utilization rate of the target switch reaches the preset upper limit of device efficiency utilization rate, it indicates that the device efficiency utilization rate of the target switch is too high, therefore the prompt information indicating that the device efficiency utilization rate is too high is output, so as to prompt the user to perform maintenance in time, and in a case where it is judged that the device efficiency utilization rate of the target switch does not reach the preset upper limit of device efficiency utilization rate, it indicates that the operation state of the target switch is normal, therefore the operation S503 is executed.

In operation S503, target device efficiency utilization rates of two neighboring switches that establish a direct communication connection with the target switch are acquired.

After the target switch having the maximum device efficiency utilization rate is determined according to the device efficiency utilization states, the target device efficiency utilization rates of the two neighboring switches that establish the direct communication connection with the target switch are acquired.

In operation S504, one of the two neighboring switches that corresponds to the greater one of the two target device efficiency utilization rates is determined as a target neighboring switch.

After the target device efficiency utilization rates of the two neighboring switches that establish the direct communication connection with the target switch are acquired, one of the two neighboring switches that corresponds to the greater one of the two target device efficiency utilization rates is determined as the target neighboring switch, so that it may be ensured that the message forwarding path between two switches having relatively high device efficiency utilization rates is determined as the redundant backup message forwarding path.

In an exemplary implementation of the embodiments of the present disclosure, the operation S504 may include the following operations 1 and 2.

In operation 1, when the two target device efficiency utilization rates are the same, MAC addresses and port numbers, which respectively correspond to the two neighboring switches, are acquired.

In operation 2, the target neighboring switch is selected from the two neighboring switches according to the MAC addresses and the port numbers.

For the sake of convenience in description, the above two operations can be combined and explained together.

When the target device efficiency utilization rates corresponding to the two neighboring switches of the target switch are the same, the MAC addresses and the port numbers, which respectively correspond to the two neighboring switches, are acquired, and the target neighboring switch is selected from the two neighboring switches according to the MAC addresses and the port numbers, thereby implementing the determination of only one target neighboring switch, which may then be used to determine the redundant backup message forwarding path.

In an exemplary implementation of the embodiments of the present disclosure, the operation that the target neighboring switch is selected from the two neighboring switches according to the MAC addresses and the port numbers may be implemented in the following manner.

A neighboring switch having a minimum combination of the MAC address and the port number is determined as the target neighboring switch.

When the target neighboring switch is selected from the two neighboring switches according to the MAC addresses and the port numbers, a neighboring switch having a minimum combination of the MAC address and the port number is determined as the target neighboring switch.

In an exemplary implementation of the embodiments of the present disclosure, the operation S502 may include the following operation.

A target switch having a maximum CPU utilization rate is determined according to the device efficiency utilization states.

Correspondingly, the operation S503 may include the following operation.

Target CPU utilization rates of the two neighboring switches that establish the direct communication connection with the target switch are acquired.

Correspondingly, the operation S504 may include the following operation.

One of the two neighboring switches that corresponds to the greater one of the two target CPU utilization rates is determined as the target neighboring switch.

For the sake of convenience in description, the above operations can be combined and explained together.

The target switch having the maximum CPU utilization rate is determined according to the device efficiency utilization states, the target CPU utilization rates of the two neighboring switches that establish the direct communication connection with the target switch are acquired, and one of the two neighboring switches that corresponds to the greater one of the two target CPU utilization rates is determined as the target neighboring switch.

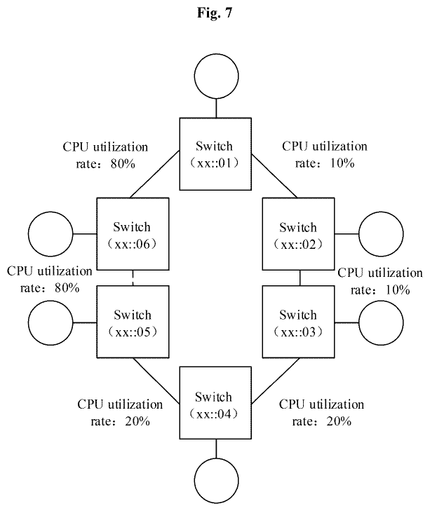

Referring to FIG. 7, FIG. 7 is a schematic diagram of a redundancy mechanism decision situation in some embodiments of the present disclosure in which CPU utilization rates are labeled. In FIG. 7, the switches having the maximum CPU utilization rate are switch [xx::05] and switch [xx::06], the CPU utilization rates of which are both 80%, according to the principle that when it is determined according to the device efficiency utilization states that the number of switches having the maximum device efficiency utilization rate is greater than 1, a switch having a minimum combination of the MAC address and the port number is determined as the target switch, switch [xx::05] is determined as the target switch. Two neighboring switches of switch [xx::05] are switch [xx::04] and switch [xx::06], wherein the CPU utilization rate of switch [xx::04] is 20%, and the CPU utilization rate of switch [xx::06] is 80%. Since the CPU utilization rate of switch [xx::06] is greater than the CPU utilization rate of switch [xx::04], switch [xx::06] is determined as the target neighboring switch, and the message forwarding path between switch [xx::05] and switch [xx::06] is determined as the redundant backup message forwarding path.

By determining, as the target switch, the switch having the maximum CPU utilization rate, and determining, as the target neighboring switch, the neighboring switch having the greater CPU utilization rate in the neighboring switches of the target switch, it may be ensured that the message forwarding path between the two selected switches having relatively high CPU utilization rates is determined as the redundant backup message forwarding path, thereby ensuring the stability of the redundant backup message forwarding path.

In an exemplary implementation of the embodiments of the present disclosure, the operation S502 may include the following operation.

A target switch having a maximum memory utilization rate is determined according to the device efficiency utilization states.

Correspondingly, the operation S503 may include the following operation.

Target memory utilization rates of the two neighboring switches that establish the direct communication connection with the target switch are acquired.

Correspondingly, the operation S504 may include the following operation.

One of the two neighboring switches that corresponds to the greater one of the two target memory utilization rates is determined as the target neighboring switch.

For the sake of convenience in description, the above operations can be combined and explained together.

The target switch having the maximum memory utilization rate is determined according to the device efficiency utilization states, the target memory utilization rates of the two neighboring switches that establish the direct communication connection with the target switch are acquired, and one of the two neighboring switches that corresponds to the greater one of the two target memory utilization rates is determined as the target neighboring switch. By determining, as the target switch, the switch having the maximum memory utilization rate, and determining, as the target neighboring switch, the neighboring switch having the greater memory utilization rate in the neighboring switches of the target switch, it may be ensured that the message forwarding path between the two selected switches having relatively high memory utilization rates is determined as the redundant backup message forwarding path, thereby ensuring the stability of the redundant backup message forwarding path.

In an exemplary implementation of the embodiments of the present disclosure, the operation S502 may include the following operation.

A target switch having a minimum access control list rule count is determined according to the device efficiency utilization states.

Correspondingly, the operation S503 may include the following operation.

Target access control list rule counts of the two neighboring switches that establish the direct communication connection with the target switch are acquired.

Correspondingly, the operation S504 may include the following operation.

One of the two neighboring switch that corresponds to the smaller one of the two target access control list rule counts is determined as the target neighboring switch.

For the sake of convenience in description, the above operations can be combined and explained together.

The target switch having the minimum access control list rule count is determined according to the device efficiency utilization states, the target access control list rule counts of the two neighboring switches that establish the direct communication connection with the target switch are acquired, and one of the two neighboring switch that corresponds to the smaller one of the two target access control list rule counts is determined as the target neighboring switch.

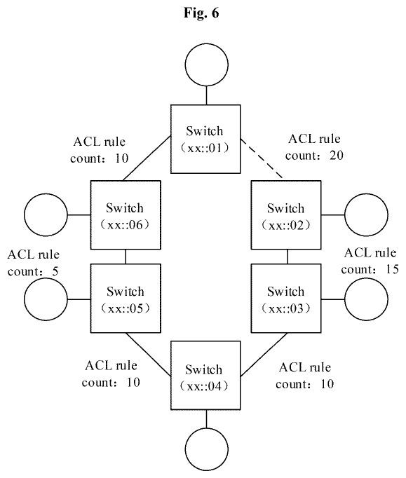

Referring to FIG. 6, FIG. 6 is a schematic diagram of a redundancy mechanism decision situation in some embodiments of the present disclosure in which access control list rule counts are labeled. In FIG. 6, the target switch having the minimum access control list rule count is switch [xx::05], the two neighboring switches of switch [xx::05] are switch [xx::04] and switch [xx::06], wherein the target access control list rule count of switch [xx::04] is 10, and the target access control list rule count of switch [xx::06] is also 10. Since switch [xx::04] and switch [xx::06] have the same target access control list rule count, according to a preset principle that when the two neighboring switches of the target switch correspond to the same target device efficiency utilization rate, a neighboring switch having a minimum combination of the MAC address and the port number is determined as the target neighboring switch, switch [xx::04] is determined as the target neighboring switch, and the message forwarding path between switch [xx::04] and switch [xx::05] is determined as the redundant backup message forwarding path.

By determining, as the target switch, the switch having the minimum access control list rule count, and determining, as the target neighboring switch, the neighboring switch having the smaller minimum access control list rule count in the neighboring switches of the target switch, it may be ensured that the message forwarding path between the two selected switches having relatively low minimum access control list rule counts is determined as the redundant backup message forwarding path, thereby ensuring the stability of the redundant backup message forwarding path.

In an exemplary implementation of the embodiments of the present disclosure, the operation S502 may include the following operation.

A target switch having a maximum port utilization rate is determined according to the device efficiency utilization states.

Correspondingly, the operation S503 may include the following operation.

Target port utilization rates of the two neighboring switches that establish the direct communication connection with the target switch are acquired.

Correspondingly, the operation S504 may include the following operation.

One of the two neighboring switches that corresponds to the greater one of the two target port utilization rates is determined as the target neighboring switch.

For the sake of convenience in description, the above operations can be combined and explained together.

The target switch having the maximum port utilization rate is determined according to the device efficiency utilization states, the target port utilization rates of the two neighboring switches that establish the direct communication connection with the target switch are acquired, and one of the two neighboring switches that corresponds to the greater one of the two target port utilization rates is determined as the target neighboring switch. By determining, as the target switch, the switch having the maximum port utilization rate, and determining, as the target neighboring switch, the neighboring switch having the greater port utilization rate in the neighboring switches of the target switch, it may be ensured that the message forwarding path between the two selected switches having relatively high target port utilization rates is determined as the redundant backup message forwarding path, thereby ensuring the stability of the redundant backup message forwarding path.

In an exemplary implementation of the embodiments of the present disclosure, the operation S502 may include the following operation.

A target switch having a maximum queue utilization rate is determined according to the device efficiency utilization states.

Correspondingly, the operation S503 may include the following operation.

Target queue utilization rates of the two neighboring switches that establish the direct communication connection with the target switch are acquired.

Correspondingly, the operation S504 may include the following operation.

One of the two neighboring switches that corresponds to the greater one of the two target queue utilization rates is determined as the target neighboring switch.

For the sake of convenience in description, the above operations can be combined and explained together.

The target switch having the maximum queue utilization rate is determined according to the device efficiency utilization states, the target queue utilization rates of the two neighboring switches that establish the direct communication connection with the target switch are acquired, and one of the two neighboring switches that corresponds to the greater one of the two target queue utilization rates is determined as the target neighboring switch. By determining, as the target switch, the switch having the maximum queue utilization rate, and determining, as the target neighboring switch, the neighboring switch having the greater queue utilization rate in the neighboring switches of the target switch, it may be ensured that the message forwarding path between the two selected switches having relatively high queue utilization rates is determined as the redundant backup message forwarding path, thereby ensuring the stability of the redundant backup message forwarding path.

In an exemplary implementation of the embodiments of the present disclosure, the operation S502 may include the following operation.

A target switch having a maximum port packet loss statistical number is determined according to the device efficiency utilization states.

Correspondingly, the operation S503 may include the following operation.

Target port packet loss statistical numbers of the two neighboring switches that establish the direct communication connection with the target switch are acquired.

Correspondingly, the operation S504 may include the following operation.

One of the two neighboring switches that corresponds to the greater one of the two target port packet loss statistical numbers is determined as the target neighboring switch.

For the sake of convenience in description, the above operations can be combined and explained together.

The target switch having the maximum port packet loss statistical number is determined according to the device efficiency utilization states, the target port packet loss statistical numbers of the two neighboring switches that establish the direct communication connection with the target switch are acquired, and one of the two neighboring switches that corresponds to the greater one of the two target port packet loss statistical numbers is determined as the target neighboring switch. By determining, as the target switch, the switch having the maximum port packet loss statistical number, and determining, as the target neighboring switch, the neighboring switch having the greater port packet loss statistical number in the neighboring switches of the target switch, it may be ensured that the message forwarding path between the two selected switches having relatively high port packet loss statistical numbers is determined as the redundant backup message forwarding path, thereby ensuring the stability of the redundant backup message forwarding path.

In operation S505, a message forwarding path between the target switch and the target neighboring switch is determined as the redundant backup message forwarding path.

After one of the two neighboring switches that corresponds to the greater one of the two target device efficiency utilization rates is determined as the target neighboring switch, the message forwarding path between the target switch and the target neighboring switch is determined as the redundant backup message forwarding path. Therefore, the message forwarding path between the two switches having relatively high device efficiency utilization rates is determined as the redundant backup message forwarding path, thereby ensuring the stability of the redundant backup message forwarding path.

Compared with the related technology in which the MAC address and the port number, which are unrelated to the actual scenario situations, are used as reference, in the embodiments of the present disclosure, information related to system efficiency and system security is used as a basis for selecting a path having relatively low impact as the redundant backup message forwarding path, and the system load is prevented from being concentrated in a specific device as much as possible, so as to ensure that each device can run stably in a lower-strength state, or that each device has enough resources to process all service requirements. The improved redundancy protocol provided in the embodiments of the present disclosure may enable the system to be in a more stable state, thereby improving the stability of the system efficiency and maintaining the system security. In addition, in order to avoid affecting the compatibility or increasing the implementation difficulty by excessively changing the protocol architecture, the embodiments of the present disclosure retain the original process architecture of the protocol and only adjusts the information carried during the protocol synchronization process, ensuring that this optimization will not greatly increase the convergence time and cause a loss of focus. This is equivalent to improving system stability without increasing performance consumption. The present application example only lists a few common pieces of information that can improve system performance as examples. In the embodiments of the present disclosure, only several pieces of information, which are capable of improving the system efficiency in general, are listed as examples, and according to the modification direction proposed in the present technical solution, devices using the optimization solution may be respectively adjusted to use the corresponding types of information according to respective requirements.

In operation S506, a target message to be forwarded is received.

In operation S507, a preset main message forwarding path is acquired.

In operation S508, when it is determined that the main message forwarding path is abnormal, the redundant backup message forwarding path selected according to the device efficiency utilization states is acquired.

In operation S509, the target message is forwarded by using the redundant backup message forwarding path.

Corresponding to the above method embodiments, an embodiment of the present disclosure further provides a message forwarding apparatus, and the message forwarding apparatus described below and the message forwarding method described above may refer to each other.

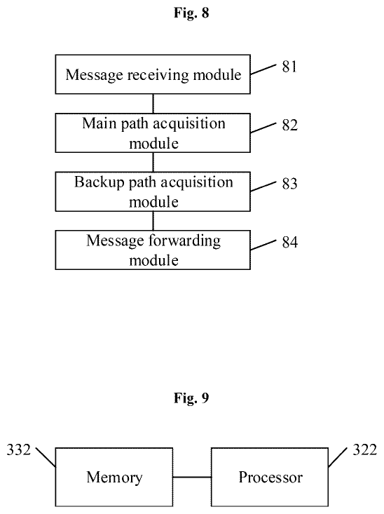

Referring to FIG. 8, FIG. 8 is a structural block diagram of a message forwarding apparatus in some embodiments of the present disclosure. The message forwarding apparatus may include:
a message receiving module 81, configured to receive a target message to be forwarded;
a main path acquisition module 82, configured to acquire a preset main message forwarding path;
a backup path acquisition module 83, configured to: when it is determined that the main message forwarding path is abnormal, acquire a redundant backup message forwarding path selected according to device efficiency utilization states; and
a message forwarding module 84, configured to forward the target message by using the redundant backup message forwarding path.

It can be seen from the above technical solutions that the redundant backup message forwarding path is selected in advance from message forwarding paths according to the device efficiency utilization states, and after the target message to be forwarded is received, when the preset main message forwarding path is abnormal, the target message is forwarded by using the redundant backup message forwarding path. Therefore, devices are effectively prevented from being in a high utilization rate state for a long time, the likelihood of anomalies or congestion occurring in the message forwarding paths is greatly reduced, the message forwarding success rate is improved, and the system stability is improved.

In an exemplary implementation of the embodiments of the present disclosure, the message forwarding apparatus may further include a backup path selection module, wherein the backup path selection module includes:
an efficiency utilization state acquisition sub-module, configured to respectively acquire device efficiency utilization states of switches;
a target switch determination sub-module, configured to determine a target switch having a maximum device efficiency utilization rate according to the device efficiency utilization states;
an efficiency utilization rate acquisition sub-module, configured to acquire target device efficiency utilization rates of two neighboring switches that establish a direct communication connection with the target switch;
a target neighboring switch determination sub-module, configured to determine, as a target neighboring switch, one of the two neighboring switches that corresponds to the greater one of the two target device efficiency utilization rates; and
a backup path determination sub-module, configured to determine, as the redundant backup message forwarding path, a message forwarding path between the target switch and the target neighboring switch.

In an exemplary implementation of the embodiments of the present disclosure, the target switch determination sub-module is a module for determining a target switch having a maximum CPU utilization rate according to the device efficiency utilization states;
the efficiency utilization rate acquisition sub-module is a module for acquiring target CPU utilization rates of the two neighboring switches that establish the direct communication connection with the target switch; and
the target neighboring switch determination sub-module is a module for determining, as the target neighboring switch, one of the two neighboring switches that corresponds to the greater one of the two target CPU utilization rates.

In an exemplary implementation of the embodiments of the present disclosure, the target switch determination sub-module is a module for determining a target switch having a maximum memory utilization rate according to the device efficiency utilization states;
the efficiency utilization rate acquisition sub-module is a module for acquiring target memory utilization rates of the two neighboring switches that establish the direct communication connection with the target switch; and
the target neighboring switch determination sub-module is a module for determining, as the target neighboring switch, one of the two neighboring switches that corresponds to the greater one of the two target memory utilization rates.

In an exemplary implementation of the embodiments of the present disclosure, the target switch determination sub-module is a module for determining a target switch having a minimum access control list rule count according to the device efficiency utilization states;
the efficiency utilization rate acquisition sub-module is a module for acquiring target access control list rule counts of the two neighboring switches that establish the direct communication connection with the target switch; and
the target neighboring switch determination sub-module is a module for determining, as the target neighboring switch, one of the two neighboring switch that corresponds to the smaller one of the two target access control list rule counts.

In an exemplary implementation of the embodiments of the present disclosure, the target switch determination sub-module is a module for determining a target switch having a maximum port utilization rate according to the device efficiency utilization states;
the efficiency utilization rate acquisition sub-module is a module for acquiring target port utilization rates of the two neighboring switches that establish the direct communication connection with the target switch; and
the target neighboring switch determination sub-module is a module for determining, as the target neighboring switch, one of the two neighboring switches that corresponds to the greater one of the two target port utilization rates.

In an exemplary implementation of the embodiments of the present disclosure, the target switch determination sub-module is a module for determining a target switch having a maximum queue utilization rate according to the device efficiency utilization states;
the efficiency utilization rate acquisition sub-module is a module for acquiring target queue utilization rates of the two neighboring switches that establish the direct communication connection with the target switch; and
the target neighboring switch determination sub-module is a module for determining, as the target neighboring switch, one of the two neighboring switches that corresponds to the greater one of the two target queue utilization rates.

In an exemplary implementation of the embodiments of the present disclosure, the target switch determination sub-module is a module for determining a target switch having a maximum port packet loss statistical number according to the device efficiency utilization states;
the efficiency utilization rate acquisition sub-module is a module for acquiring target port packet loss statistical numbers of the two neighboring switches that establish the direct communication connection with the target switch; and
the target neighboring switch determination sub-module is a module for determining, as the target neighboring switch, one of the two neighboring switches that corresponds to the greater one of the two target port packet loss statistical numbers.

In an exemplary implementation of the embodiments of the present disclosure, the efficiency utilization rate acquisition sub-module is a module for respectively acquiring efficiency index utilization rates corresponding to each of the switches;
the target switch determination sub-module includes:
a weight acquisition unit, configured to acquire preset weights corresponding to respective efficiency indexes;
an efficiency utilization rate calculation unit, configured to: for each of the switches, perform weighted average on the efficiency index utilization rates according to the preset weights, so as to obtain the device efficiency utilization rate; and
a target switch determination sub-unit, configured to determine, as the target switch, the switch having the maximum device efficiency utilization rate.

In an exemplary implementation of the embodiments of the present disclosure, the target switch determination sub-module includes:
a first address and port number acquisition unit, configured to: when it is determined according to the device efficiency utilization states that the number of switches having the maximum device efficiency utilization rate is greater than 1, acquire MAC addresses and port numbers, which respectively correspond to the switches having the maximum device efficiency utilization rate; and
a target switch selection unit, configured to select, according to the MAC addresses and the port numbers, the target switch from the switches having the maximum device efficiency utilization rate.

In an exemplary implementation of the embodiments of the present disclosure, the target switch selection unit is a unit for determining, as the target switch, a switch having a minimum combination of the MAC address and the port number.

In an exemplary implementation of the embodiments of the present disclosure, the target neighboring switch determination sub-module includes:
a second address and port number acquisition unit, configured to: when the two target device efficiency utilization rates are the same, acquire MAC addresses and port numbers, which respectively correspond to the two neighboring switches; and
a target neighboring switch selection unit, configured to select the target neighboring switch from the two neighboring switches according to the MAC addresses and the port numbers.

In an exemplary implementation of the embodiments of the present disclosure, the target neighboring switch selection unit is a unit for determining, as the target neighboring switch, a neighboring switch having a minimum combination of the MAC address and the port number.

In an exemplary implementation of the embodiments of the present disclosure, the message forwarding apparatus may further include:
a judging module, configured to: after determining the target switch having the maximum device efficiency utilization rate according to the device efficiency utilization states, judge whether the device efficiency utilization rate of the target switch reaches a preset upper limit of device efficiency utilization rate; and
a prompt information output module, configured to: in a case where it is determined currently that the device efficiency utilization rate of the target switch reaches the preset upper limit of device efficiency utilization rate, output prompt information indicating that the device efficiency utilization rate is too high.

In an exemplary implementation of the embodiments of the present disclosure, the message forwarding module 84 is a module for forwarding the target message by using the redundant backup message forwarding path, when an initiative restart mechanism is triggered.

Corresponding to the above method embodiments, referring to FIG. 9, FIG. 9 is a schematic diagram of a message forwarding device in some embodiments of the present disclosure. The device may include:
a memory 332, configured to store a computer program; and
a processor 322, configured to implement the operations of the message forwarding method in the above method embodiments when executing the computer program.

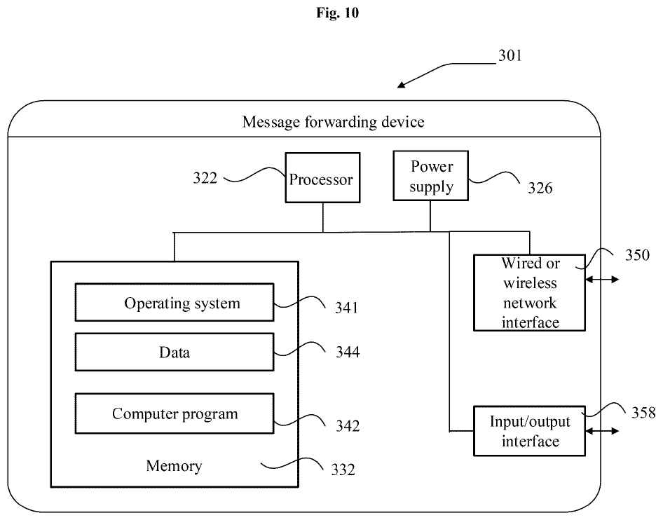

Referring to FIG. 10, FIG. 10 is an exemplary schematic structural diagram of a message forwarding device in some embodiments of the present disclosure. The message forwarding device may generate a relatively large difference due to different configurations or performance, and may include a processor (for example, a Central Processing Unit (CPU)) 322 (for example, one or more central processing units) and a memory 332, wherein the memory 332 stores one or more computer applications 342 or data 344, and the memory 332 may be a temporary storage or a persistent storage. The program stored in the memory 332 may include one or more modules (not shown), and each module may include a series of instruction operations in a data processing device. The processor 322 may be configured to communicate with the memory 332, and to execute, on a message forwarding device 301, the series of instruction operations in the memory 332.

The message forwarding device 301 may further include one or more power supplies 326, one or more wired or wireless network interfaces 350, one or more input/output interfaces 358, and/or one or more operating systems 341.

The operations in the message forwarding method described above may be implemented by the structure of the message forwarding device.

Corresponding to the above method embodiments, an embodiment of the present disclosure further provides a non-volatile readable storage medium, storing a computer program thereon, wherein the computer program, when executed by a processor, implements the following operations:
a target message to be forwarded is received; a preset main message forwarding path is acquired; when it is determined that the main message forwarding path is abnormal, a redundant backup message forwarding path selected according to device efficiency utilization states is acquired; and the target message is forwarded by using the redundant backup message forwarding path.

The non-volatile readable storage medium may include a variety of media capable of storing program codes, such as a Universal Serial Bus (USB) disk, a mobile hard disk, a Read-Only Memory (ROM), a Random Access Memory (RAM), a magnetic disk, or an optical disk.

For the description of the non-volatile readable storage medium provided in the embodiments of the present disclosure, reference may be made to the above method embodiments, thus details are not described in the embodiments of the present disclosure again.

The embodiments in the present specification are described in a progressive manner, what is highlighted in each embodiment is difference with other embodiments, and the identical or similar parts between the embodiments refer to each other. The message forwarding apparatus, the device and the non-volatile readable storage medium disclosed in the embodiments correspond to the message forwarding method disclosed in the embodiments, thus is described simply, and related parts may see a part of illustration to the method embodiments.

The principles and implementations of the embodiments of the present disclosure are described herein by using optional examples, and the descriptions of the above embodiments are merely used to help understand the technical solutions and the core ideas of the embodiments of the present disclosure. It should be noted that, for those having ordinary skill in the art, several improvements and modifications may also be made to the embodiments of the present disclosure without departing from the principles of the embodiments of the present disclosure, and these improvements and modifications also fall within the protection scope of the claims of the present disclosure.

1. A message forwarding method, comprising:
receiving a target message to be forwarded;
acquiring a preset main message forwarding path;
when it is determined that the main message forwarding path is abnormal, acquiring a redundant backup message forwarding path selected according to device efficiency utilization states; and
forwarding the target message by using the redundant backup message forwarding path.

2. The message forwarding method according to claim 1, further comprising a process of selecting the redundant backup message forwarding path, wherein the process of selecting the redundant backup message forwarding path comprises:
respectively acquiring the device efficiency utilization states of switches;
determining a target switch having a maximum device efficiency utilization rate according to the device efficiency utilization states;
acquiring target device efficiency utilization rates of two neighboring switches that establish a direct communication connection with the target switch;
determining, as a target neighboring switch, one of the two neighboring switches that corresponds to the greater one of the two target device efficiency utilization rates; and
determining, as the redundant backup message forwarding path, a message forwarding path between the target switch and the target neighboring switch.

3. The message forwarding method according to claim 2, wherein determining the target switch having the maximum device efficiency utilization rate according to the device efficiency utilization states comprises:
determining a target switch having a maximum Central Processing Unit (CPU) utilization rate according to the device efficiency utilization states;
wherein acquiring the target device efficiency utilization rates of the two neighboring switches that establish the direct communication connection with the target switch comprises:
acquiring target CPU utilization rates of the two neighboring switches that establish the direct communication connection with the target switch; and
wherein determining, as the target neighboring switch, one of the two neighboring switches that corresponds to the greater one of the two target device efficiency utilization rates comprises:
determining, as the target neighboring switch, one of the two neighboring switches that corresponds to the greater one of the two target CPU utilization rates.

4. The message forwarding method according to claim 2, wherein determining the target switch having the maximum device efficiency utilization rate according to the device efficiency utilization states comprises:
determining a target switch having a maximum memory utilization rate according to the device efficiency utilization states;
wherein acquiring the target device efficiency utilization rates of the two neighboring switches that establish the direct communication connection with the target switch comprises:
acquiring target memory utilization rates of the two neighboring switches that establish the direct communication connection with the target switch; and
wherein determining, as the target neighboring switch, one of the two neighboring switches that corresponds to the greater one of the two target device efficiency utilization rates comprises:
determining, as the target neighboring switch, one of the two neighboring switches that corresponds to the greater one of the two target memory utilization rates.

5. The message forwarding method according to claim 2, wherein determining the target switch having the maximum device efficiency utilization rate according to the device efficiency utilization states comprises:
determining a target switch having a minimum access control list rule count according to the device efficiency utilization states;
wherein acquiring the target device efficiency utilization rates of the two neighboring switches that establish the direct communication connection with the target switch comprises:
acquiring target access control list rule counts of the two neighboring switches that establish the direct communication connection with the target switch; and
wherein determining, as the target neighboring switch, one of the two neighboring switches that corresponds to the greater one of the two target device efficiency utilization rates comprises:
determining, as the target neighboring switch, one of the two neighboring switch that corresponds to the smaller one of the two target access control list rule counts.

6. The message forwarding method according to claim 2, wherein determining the target switch having the maximum device efficiency utilization rate according to the device efficiency utilization states comprises:
determining a target switch having a maximum port utilization rate according to the device efficiency utilization states;
wherein acquiring the target device efficiency utilization rates of the two neighboring switches that establish the direct communication connection with the target switch comprises:
acquiring target port utilization rates of the two neighboring switches that establish the direct communication connection with the target switch; and
wherein determining, as the target neighboring switch, one of the two neighboring switches that corresponds to the greater one of the two target device efficiency utilization rates comprises:
determining, as the target neighboring switch, one of the two neighboring switches that corresponds to the greater one of the two target port utilization rates.

7. The message forwarding method according to claim 2, wherein determining the target switch having the maximum device efficiency utilization rate according to the device efficiency utilization states comprises:
determining a target switch having a maximum queue utilization rate according to the device efficiency utilization states;
wherein acquiring the target device efficiency utilization rates of the two neighboring switches that establish the direct communication connection with the target switch comprises:
acquiring target queue utilization rates of the two neighboring switches that establish the direct communication connection with the target switch; and
wherein determining, as the target neighboring switch, one of the two neighboring switches that corresponds to the greater one of the two target device efficiency utilization rates comprises:
determining, as the target neighboring switch, one of the two neighboring switches that corresponds to the greater one of the two target queue utilization rates.

8. The message forwarding method according to claim 2, wherein determining the target switch having the maximum device efficiency utilization rate according to the device efficiency utilization states comprises:
determining a target switch having a maximum port packet loss statistical number according to the device efficiency utilization states;
wherein acquiring the target device efficiency utilization rates of the two neighboring switches that establish the direct communication connection with the target switch comprises:
acquiring target port packet loss statistical numbers of the two neighboring switches that establish the direct communication connection with the target switch; and
wherein determining, as the target neighboring switch, one of the two neighboring switches that corresponds to the greater one of the two target device efficiency utilization rates comprises:
determining, as the target neighboring switch, one of the two neighboring switches that corresponds to the greater one of the two target port packet loss statistical numbers.

9. The message forwarding method according to claim 2, wherein respectively acquiring the device efficiency utilization states of the switches comprises: respectively acquiring efficiency index utilization rates corresponding to each of the switches;
wherein determining the target switch having the maximum device efficiency utilization rate according to the device efficiency utilization states comprises:
acquiring preset weights corresponding to respective efficiency indexes;
for each of the switches, performing weighted average on the efficiency index utilization rates according to the preset weights, so as to obtain the device efficiency utilization rate; and
determining, as the target switch, the switch having the maximum device efficiency utilization rate.

10. The message forwarding method according to claim 2, wherein determining the target switch having the maximum device efficiency utilization rate according to the device efficiency utilization states comprises:
when it is determined according to the device efficiency utilization states that the number of switches having the maximum device efficiency utilization rate is greater than 1, acquiring Media Access Control (MAC) addresses and port numbers, which respectively correspond to the switches having the maximum device efficiency utilization rate; and
selecting, according to the MAC addresses and the port numbers, the target switch from the switches having the maximum device efficiency utilization rate.

11. The message forwarding method according to claim 10, wherein selecting, according to the MAC addresses and the port numbers, the target switch from the switches having the maximum device efficiency utilization rate comprises:
determining, as the target switch, a switch having a minimum combination of the MAC address and the port number.

12. The message forwarding method according to claim 10, wherein determining, as the target neighboring switch, one of the two neighboring switches that corresponds to the greater one of the two target device efficiency utilization rates comprises:
when the two target device efficiency utilization rates are the same, acquiring MAC addresses and port numbers, which respectively correspond to the two neighboring switches; and
selecting the target neighboring switch from the two neighboring switches according to the MAC addresses and the port numbers.

13. The message forwarding method according to claim 12, wherein selecting the target neighboring switch from the two neighboring switches according to the MAC addresses and the port numbers comprises:
determining, as the target neighboring switch, a neighboring switch having a minimum combination of the MAC address and the port number.

14. The message forwarding method according to claim 2, wherein after determining the target switch having the maximum device efficiency utilization rate according to the device efficiency utilization states, the message forwarding method further comprises:
judging whether the device efficiency utilization rate of the target switch reaches a preset upper limit of device efficiency utilization rate; and
in a case where it is judged that the device efficiency utilization rate of the target switch reaches the preset upper limit of device efficiency utilization rate, outputting prompt information indicating that the device efficiency utilization rate is too high.

15. The message forwarding method according to claim 1, wherein forwarding the target message by using the redundant backup message forwarding path comprises:
when an initiative restart mechanism is triggered, forwarding the target message by using the redundant backup message forwarding path.

16. The message forwarding method according to claim 2, wherein acquiring the target device efficiency utilization rates of the two neighboring switches that establish the direct communication connection with the target switch comprises:
in a case where it is judged that the device efficiency utilization rate of the target switch does not reach a preset upper limit of device efficiency utilization rate, acquiring the target device efficiency utilization rates of the two neighboring switches that establish the direct communication connection with the target switch.

17. The message forwarding method according to claim 12, further comprising:
determining that the two target device efficiency utilization rates are the same when the target CPU utilization rates of the two neighboring switches are the same, or the target memory utilization rates of the two neighboring switches are the same, or the target access control list rule counts of the two neighboring switches are the same, or the target port utilization rates of the two neighboring switches are the same, or the target queue utilization rates of the two neighboring switches are the same, or the target port packet loss statistical numbers of the two neighboring switches are the same.

18. (canceled)

19. A message forwarding device, comprising:
a memory, configured to store a computer program; and
a processor, configured to implement the following operations when executing the computer program:
receiving a target message to be forwarded;
acquiring a preset main message forwarding path;
when it is determined that the main message forwarding path is abnormal, acquiring a redundant backup message forwarding path selected according to device efficiency utilization states; and
forwarding the target message by using the redundant backup message forwarding path.

20. A non-transitory non-volatile readable storage medium, storing a computer program, wherein the computer program, when executed by a processor, implements the following operations:
receiving a target message to be forwarded;
acquiring a preset main message forwarding path;
when it is determined that the main message forwarding path is abnormal, acquiring a redundant backup message forwarding path selected according to device efficiency utilization states; and
forwarding the target message by using the redundant backup message forwarding path.

21. The message forwarding method according to claim 9, wherein the efficiency index utilization rates corresponding to each of the switches comprise at least one of: a Central Processing Unit (CPU) utilization rate, a memory utilization rate, an access control list rule count, a port utilization rate, a queue utilization rate, and a port packet loss statistical number.
